(19) United States
(12) Patent Application Publication
(10) Pub. No.: US 2003/0038802 A1
(43) Pub. Date: Feb. 27, 2003

(54) Automatic delineation of heart borders and surfaces from images

(76) Inventors: Richard K. Johnson, Sammamish, WA (US); John Alan McDonald, Seattle, WA (US); Florence H. Sheehan, Mercer Island, WA (US)

Correspondence Address: LAW OFFICES OF RONALD M. ANDERSON, Suite 507, 600-108th Avenue N.E., Bellevue, WA, 98004, US

(21) Appl. No.: 10/227,252

(22) Filed: Aug. 23, 2002

Related U.S. Application Data
(60) Provisional application No. 60/315,237, filed on Aug. 23, 2001.
(60) Provisional application No. 60/315,238, filed on Aug. 23, 2001.

(51) Int. Cl. G06T 17/00

(52) U.S. Cl. 345/420

(57) ABSTRACT

A method for fitting a surface to some portion of a patient's heart. In the method, ultrasound imaging is carried out over at least one cardiac cycle, providing a plurality of images in different image planes made with a transducer at known positions and orientations. An operator selects points on some of the images that correspond to the surface of interest, and a surface is automatically fit to the points in three dimensions, using prior knowledge about heart anatomy to constrain the fitted shape to a reasonable result. The operator reviews the fitted surface, in 3D or alternatively, as intersected with the images. If the fit is acceptable, the process is done. Otherwise, the image processing is repetitively carried out, guided by the fitted surface, to produce additional data points, until an acceptable fit is obtained. The resulting output surface can be used in determining cardiac parameters.

### RELATED APPLICATIONS

This application is based on U.S. Provisional Patent Application Serial Nos. 60/315,237 and 60/315,238, both filed on Aug. 23, 2001, the benefit of the filing date of which is hereby claimed under 35 U.S.C. § 119(e).

### GOVERNMENT RIGHTS

This invention was made with federal government support under HL-59054 awarded by the National Institutes of Health, and the federal government has certain rights to the invention.

### FIELD OF THE INVENTION

The present invention generally relates to automatically identifying and delineating the boundary or contour of an internal organ from image data, and more specifically, to automatically delineating the surfaces of an organ such as a heart, by processing image data from multiple planes in three-dimensional (3D) space, using data derived from images of other such organs.

### BACKGROUND OF THE INVENTION

Much effort has been expended over the past 15 years to develop an automated contour delineation algorithm for echocardiograms. The task is difficult because ultrasound images are inherently subject to noise, and the endocardial and epicardial contours comprise multiple tissue elements. Most of the research has been devoted to detection of contours from two-dimensional (2D) echo images. At first, attempts were made to trace the ventricular contour from static images. The earliest algorithms were gradient based edge detectors that searched among the gray scale values of the image pixels for a transition from light to dark, which might correspond to the border between the myocardium and the blood in a ventricular chamber. It was then necessary to identify those edge segments that should be strung together to form the ventricular contour. This task was typically performed by looking for local shape consistency and avoiding abrupt changes in contour direction. The edge detectors were usually designed to search radially from the center of the ventricle to locate the endocardial and epicardial contours. These prior art techniques were most applicable to short axis views. The application of an elliptical model enabled contour detection in apical views in which the left ventricle appears roughly elliptical in shape; however, the irregular contour in the region of the two valves at the basal end could not be accurately delineated. Another problem with some of the early edge detectors was that they traced all contours of the ventricular endocardium indiscriminately around and between the trabeculae carneae and papillary muscles. Subsequent methods were able to ignore these details of the musculature and to trace the smoother contour of the underlying endocardium.

A matched filtering approach has also been used for contour detection as reported in “Matched Filter Identification of Left-Ventricular Endocardial Borders in Transesophageal Echocardiograms”, Trans. Med. Imag. 9:396-404 (1990), P. R. Detmer, G. Bashein, and R. W. Martin. This method used a filter computed from average grayscale values to find contour locations along radial lines from the ventricle center. The method was only used for short axis views, which provide a closed contour. It was not successful in regions with low signal-to-noise ratio.

Contour delineation accuracy improved when algorithms began to incorporate information available from tracking the motion of the heart as it contracts and expands with each beat during the cardiac cycle, instead of operating on a single static image. Indeed, human observers almost always utilize this type of temporal information when they trace contours manually. Similarities between temporally adjacent image frames are used to help fill in discontinuities or areas of signal dropout in an image, and to smooth the rough contours obtained using a radial search algorithm. The problems with these prior art methods are that: (a) the operator generally has to manually trace the ventricular contour or identify a region of interest in the first image of the time series, (b) the errors at any frame in the series may be propagated to subsequent frames, and (c) the cardiac parameters of greatest clinical interest are derived from analysis of only two time points in the cardiac cycle—end diastole and end systole—and do not require frame-by-frame analysis.

Another way to utilize timing information is to measure the velocity of regional ventricular wall motion using optical flow techniques. However, wall motion and wall thickening are the parameters used clinically to evaluate cardiac status, not velocity. Also, such velocity measurements are very much subject to noise in the image, because the change in gray level from one image to the next may be caused by signal dropout or noise, rather than by the motion of the heart walls.

The algorithm developed by Geiser et al. in “Autonomous epicardial and endocardial boundary detection in echocardiographic short-axis images.” Journal of The American Society of Echocardiography, 11(4):338-48 (1998) is more accurate in contour delineation than those previously reported. The Geiser et al. algorithm incorporates not only temporal information, but also knowledge about the expected homogeneity of regional wall thickness by considering both the endocardial and epicardial contours. In addition, knowledge concerning the expected shape of the ventricular contour is applied to assist in connecting edge segments together into a contour. However, this method cannot be applied to 3D echocardiograms, because the assumptions concerning ventricular shape are specific for standard 2D imaging planes, such as the parasternal short axis view at mid ventricle, or the apical four chamber view. In a 3D scan, the imaging planes may have a variety of locations and orientations in space. Another problem is that one of the assumptions used to select and connect edge segments—that the contour is elliptical—may not be valid under certain disease conditions in which the curvature of the interventricular septum is reversed.

Another way to use heart shape information is as a post processing step. As reported in “Automatic Contour Definition on left Ventriculograms by Image Evidence and a Multiple Template-Based Model,” IEEE Trans. Med. Imag. 8:173-185 (1989), Lilly et al. used templates based on manually traced contours to verify the anatomical feasibility of the contours detected by their algorithm, and to make corrections to the contours. This method has only been used for contrast ventriculograms, however, and is probably not applicable to multiplanar echocardiographic images.

Automated contour delineation algorithms for 3D image sets at first merely extended the one and 2D gradient based edge detectors to the spatial dimension. Some authors found edges in the individual 2D images and then connected them into a surface. Others found edges based on 3D gradients. However, as was seen in dealing with 2D images, the problem is not to find gray scale edges, but rather to identify which of the many edges found in each image should be retained and connected to reconstruct the ventricular surface. A number of investigators have moved from connecting contour segments using simple shape models based on local smoothness criteria in space and time, to starting with a closed contour and deforming it to fit the image. An advantage of this approach is that the fitting procedure itself produces a surface reconstruction of the ventricle.

In their paper entitled, “Recovery of the 3-D Shape of the Left Ventricle from Echocardiographic Images,” IEEE Trans. Med. Imag. 14:301-317 (1995), Coppini et al. explain how they employed a plastic surface that deforms to fit the gray scale information, to develop a 3D shape. However their surface is basically a sphere pulled by springs, and cannot capture the complex anatomic shape of the ventricle with its outflow tract and valves. |This limitation is important because, although the global parameters of volume and mass are relatively insensitive to small localized errors, analysis of ventricular shape and regional function require accurate contour detection and reconstruction of the ventricular surface.

A |contour detection method that utilizes a knowledge based model of the ventricular contour called the active shape model. (See T. F. Cootes, A. Hill, C. J. Taylor, and J. Haslam, “Use of Active Shape Models for Locating Structures in Medical Images,” which is included in Information Processing Medical Imaging, edited by H. H. Barrett and A. F. Gmitro, Berlin, Springer-Verlag, pp. 33-47, 1993.) Active shape models use an iterative refinement algorithm to search the image. The principal difference is that the active shape model can only be deformed in ways that are consistent with the statistical model derived from training data. This model of the shape of the ventricle is generated by performing a principal components analysis of the manually traced contours from a set of training images derived from ultrasound studies. The contours include a number of specific landmarks, which are consistently located, and represent the same point in each study. Each landmark is associated with a profile model passing through it and perpendicular to the local contour, which is determined from the gray scale characteristics of the training data. Automated contour detection is performed by adjusting each landmark along its profile direction to the point where its model profile best matches the image, and then a new active shape model is computed. This approach was developed for 2D and requires that the landmarks be consistently identified and located on all the images—something that is not possible for a smooth object like a heart with images acquired along variable image planes. The profiles of this method are normalized by using the derivatives of the image grayscale levels. This approach increases noise and works poorly with ultrasound images.

In U.S. Pat. No. 6,106,466, Sheehan et al. developed a mesh model for the left ventricle from a set of training data. This mesh is developed by an archetype and covariance that defines the extent of variation of control vertices in the mesh for the population of training data. The mesh model is rigidly aligned with the images of the patient's heart. Predicted images in planes corresponding to those of the images for the patient's heart and derived from the mesh model are compared to corresponding images of the patient's heart. Control vertices are iteratively adjusted to optimize the fit of the predicted images to the observed images of the patient's heart. This adjustment and comparison continues until an acceptable fit is obtained. In a development of this method that has not yet been published, the problem was formulated in a Bayesian framework, such that the inference made about a surface model is based on the integration of both the low-level image evidence and the high-level prior shape knowledge through a pixel class prediction mechanism. In this approach the surface is modified so that the distance between the data images and images computed from the surface is minimized. This process currently takes approximately as long to develop the surface as manual tracing.

Accordingly, it will be evident that there is a need for a new approach to surface delineation for 3D reconstruction of cardiac structures from ultrasound scans, which correctly identifies and delineates segments of the ventricular surface in a plurality of imaging planes, enabling an anatomically accurate reconstruction to be produced in a relatively short time. The method used in this novel approach should not assume any fixed spacing between imaging planes, but instead, should be applicable to images from a combination of imaging plane locations and orientations in space. In addition, the method should be applicable to reconstructing both the endocardial and epicardial contours, and to images acquired at any time point in the cardiac cycle.

### SUMMARY OF THE INVENTION

In accordance with the present invention, a method for delineating a 3D surface of a heart (for example, the heart of a patient) includes the step of imaging the heart to produce imaging data that define a plurality of observed images extending through the heart, with known positions and orientations. The method employs a surface fit using a knowledge base of surfaces and images derived from data collected by imaging and tracing shapes of a plurality of other hearts. A plurality of 3D points on the surface of the heart are identified in the observed images, and the surface is then fit to these 3D points. Candidate heart borders are determined by intersecting the resulting surface with the image planes. The resulting surface may be improved by processing the images in the vicinity of the candidate borders to detect likely border points, and the fitting process may be repeated with the addition of these likely border points. The method produces a surface for the patient's heart and detected borders for the images.

The step of imaging preferably comprises the step of producing ultrasonic images of the heart using an ultrasonic imaging device disposed at known positions and orientations relative to the patient's heart. In addition, the patient's heart is preferably imaged at a plurality of times during a cardiac cycle, including at an end diastole and at an end systole.

To optimize the fit of the surface to 3D data points derived from the images of the patient's heart, the geometry parameters of the surface are iteratively adjusted to optimize a fit quality measure. The fit quality measure includes distance from the point data to the surface. The distance calculation may be restricted by labeling subsets of both the data and the surface, and measuring distances between labeled data points and the correspondingly labeled parts of the surface. The fit quality measure may also include other criteria such as surface smoothness and the likelihood of observing a heart with the given shape. The method includes the step of determining if the shape of the fitted surface is clinically probable and thus, acceptable, and if not, an operator may elect to manually enter additional points and rerun the fit. Alternatively, additional points may be added automatically.

In a preferred application of the invention, the surface represents the left ventricle of a patient's heart. Preferably, the surface obtained in the disclosed application of the present invention is determined for different parts of a cardiac cycle. However, it is contemplated that the present invention can alternatively be used to determine the shapes and/or borders of other internal organs based on images of the organs.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a top level or overview flow chart that generally defines the steps of the method for automatically delineating the borders of a patient's left ventricle from images thereof;

FIG. 2 illustrates block diagram of a system in accordance with the present invention, for use in imaging the heart (or other organ) of a patient and to enable analysis of the images to determine cardiac (or other types of) parameters;

FIG. 3 is a schematic cross-sectional view of an exemplary left ventricle, as ultrasonically imaged along a transverse axis, indicating anatomic landmarks associated with the left ventricle;

FIG. 4 is a schematic cross-sectional view of the left ventricle, ultrasonically imaged along a longitudinal axis, indicating anatomic landmarks;

FIG. 5 is a flow chart illustrating the steps followed to manually trace anatomic landmarks from a heart image data set;

FIG. 6 is a flowchart illustrating the steps of the surface optimization process;

FIG. 7 is a flow chart illustrating the steps followed to generate the knowledge base of surfaces;

FIG. 8 is an illustration of part of a labeled triangular mesh;

FIG. 9 is a schematic diagram of a surface intersected by an imaging plane;

FIG. 10 is a flow chart illustrating the steps followed to decide whether to terminate the process;

FIG. 11 is a flow chart illustrating the steps followed to detect new border points; and

FIG. 12 is a flow chart illustrating the steps followed to generate the knowledge base of border templates.

### DESCRIPTION OF THE PREFERRED EMBODIMENT

While the present invention is expected to be applicable to imaging data produced by other types of imaging modalities such as computed tomography (CT) and magnetic resonance imaging (MRI), in a preferred embodiment discussed below, ultrasound imaging is employed to provide the imaging data. However, it will be understood that the present invention is not limited to use with ultrasound imaging data.

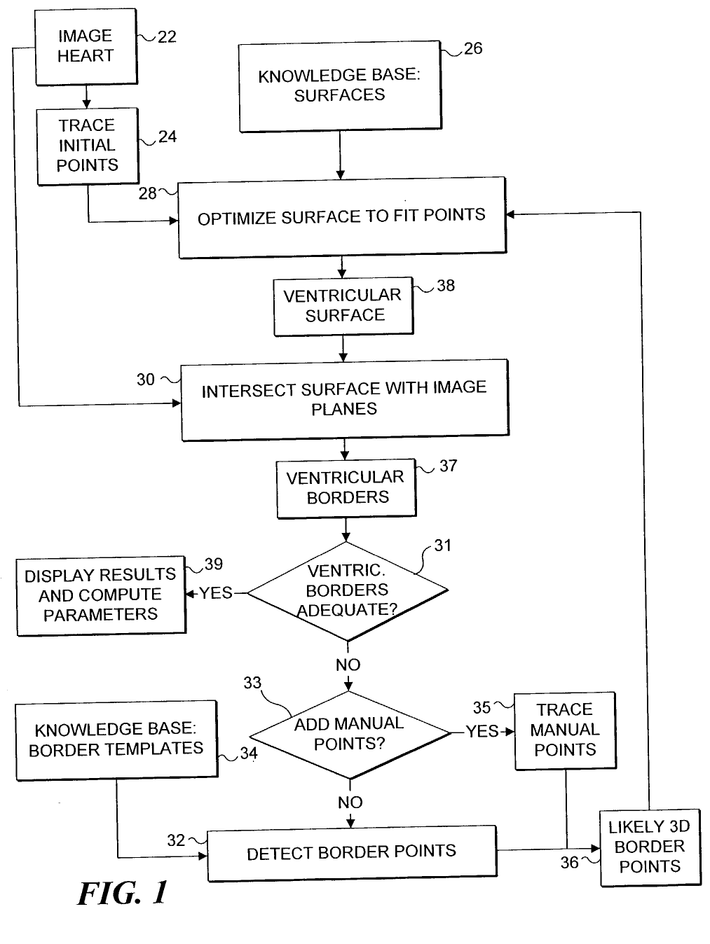

FIG. 1 includes a top level or overview flow chart 20 that broadly defines the steps of a preferred method used in the present invention for automatically detecting the borders of the left ventricle of the heart and for producing a surface of that (or another portion of the heart) based upon the ultrasound scan. In a block 22 of FIG. 1, the image data for the heart are acquired by imaging the heart in multiple planes whose location and orientation in 3D space are known and recorded. In a block 24, initial points, representing locations on the anatomy of interest, are manually traced by an operator in one or more of the images that were created in block 22, and the initial points are converted to a set of 3D points in a common coordinate system.

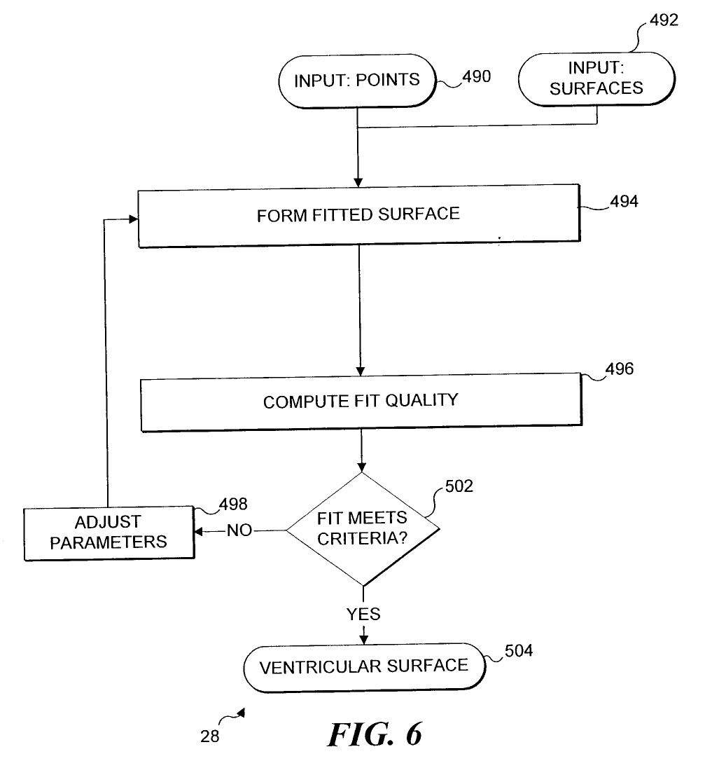

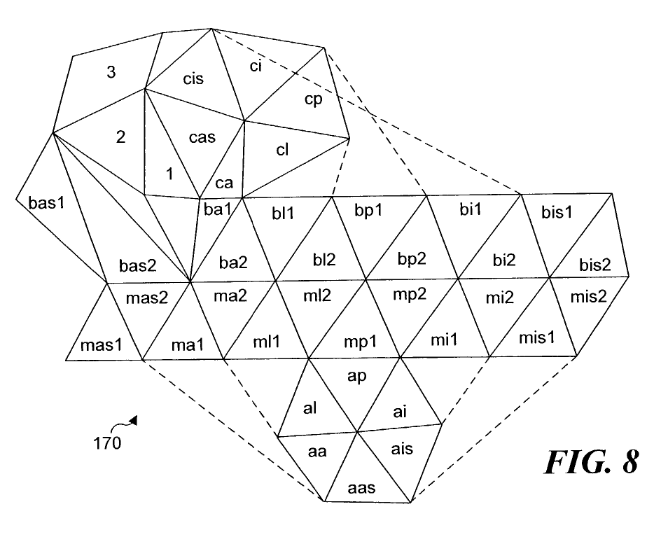

A knowledge base in a block 26 includes fitted surfaces corresponding to surfaces of the left ventricle. These surfaces are determined from prior studies that have been manually or automatically processed for a number of other hearts. Details of an exemplary surface 170 are shown in FIG. 8. In a block 28 of FIG. 1, a surface is generated from the knowledge base and adjusted to fit the data points (both initial and any additional border points that are reiteratively added). Details of the steps implemented in carrying out this fitting process are shown in FIG. 6, which is discussed below.

In a block 30, the resulting surface is computationally intersected with image planes of the recorded images. The intersections define borders, which are used to initialize the image processing and to provide feedback to the operator.

An acceptance decision is made in a block 31. This acceptance decision is based on “goodness of fit” parameters computed in block 28 and optionally, can depend upon operator approval of the surface or borders.

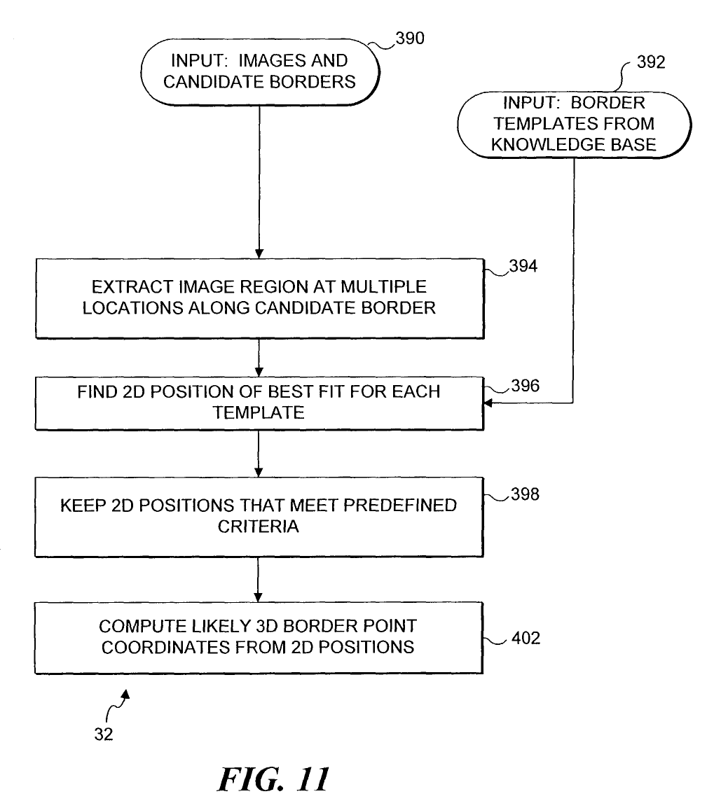

In a block 32 of FIG. 1, border point detection is performed to enable further refinement of the match between the surface and the image data for the heart of the patient. Likely border point locations are detected in the images of the patient's heart, near the intersection curves of the surface and the image planes. Details of this process are shown in FIG. 11 and are discussed below.

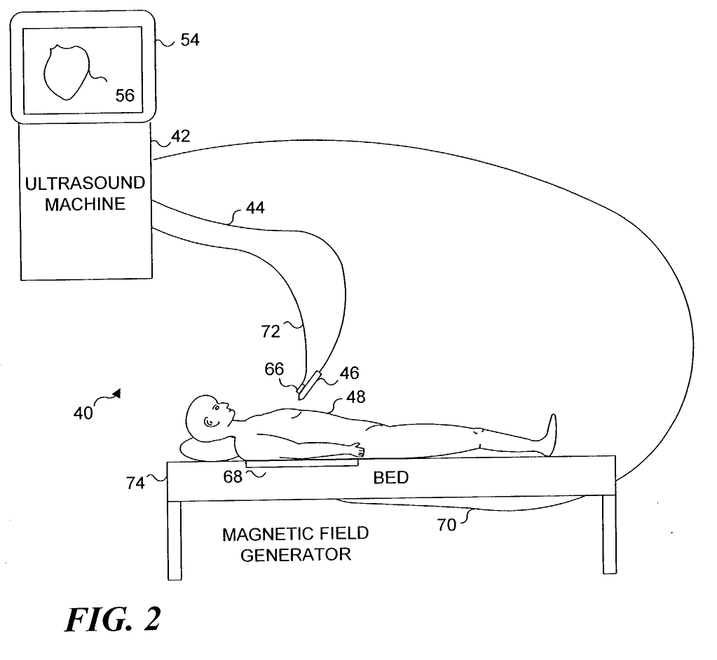

With reference to FIG. 2, a system 40 is shown for producing ultrasonic images of the heart a patient 48. An ultrasound transducer 46 is driven to produce ultrasound waves in response to a signal conveyed from an ultrasound machine 42 over a cable 44. The ultrasound waves produced by ultrasound transducer 46 propagate into the chest of patient 48 (who will normally be lying on his/her left side, although not shown in this disposition in FIG. 2) and are reflected back to the ultrasound transducer, conveying image data indicating the spatial disposition of organs, tissue, and bone within the patient's body that reflect the ultrasound signal differently. The reflected ultrasound waves are converted into a corresponding signal by ultrasound transducer 46, and this signal, which defines the reflected image data, is conveyed to ultrasound machine 42 over cable 44. Ultrasound machine 42 produces an ultrasound image 56 appearing on a display 54.

Of primary interest in regard to the present invention are the images of the ultrasound reflections from the heart of patient 48. As shown in FIG. 2, ultrasound transducer 46 is generally positioned on the patient's chest so that the ultrasound waves emitted by the sensor propagate through the heart of the patient. However, there is no requirement to position the ultrasound transducer at any exact angle or position, since its orientation and position are monitored and recorded, as explained below.

Ultrasound machine 42 also receives a digital signal from a position and orientation sensor 66 over a lead 72, which is associated with the image produced by ultrasound machine 42 in response to the reflected ultrasound. Position and orientation sensor 66 produces a signal responsive to a magnetic field produced by a magnetic field generator 68, which is mounted near the patient, e.g., under the patient's body.

Since the position and orientation sensor is attached to ultrasound transducer 46, it provides a signal indicative of the position and orientation of the ultrasound transducer relative to the magnetic field generator. The time varying position and orientation of the ultrasound transducer relative to magnetic field generator 68 comprise data that are stored in the ultrasound machine, along with other data indicative of the pixels comprising the ultrasound images of the patient's heart (or other organ). Thus, the position and orientation data enable the ultrasound machine to compute the 3D coordinates of every pixel comprising each image frame relative to the coordinate system of magnetic field generator 68.

The patient's heart (or other organ) is preferably imaged with ultrasound transducer 46 disposed at two or more substantially different positions (e.g., from both the front and side of the patient's chest) and at multiple orientations at each position so that the resulting imaging data include images for a plurality of different imaging planes. The image planes may be randomly oriented relative to each other; there is no requirement that the image planes be acquired in parallel planes or at fixed rotational angles to each other. The images are recorded at a plurality of time points in a cardiac cycle including, at a minimum, an end diastole, when the heart is maximally filled with blood, and at end systole, when the heart is maximally contracted. Each image comprises a plurality of pixels, each pixel having a gray scale value. The images preferably include a region of interest in which the left (or right) ventricle is disposed, since most information of interest relating to the condition of the patient's heart is obtained by analyzing the 3D contours of this portion of the heart. However, it should be emphasized that although the preferred embodiment of the present invention is disclosed, by way of example, in connection with automatically determining the endocardial and epicardial contours of the left ventricle as surfaces, the invention is equally applicable and useful in automatically determining the contours of other chambers of the heart, so that other parameters generally indicative of the condition of the patient's heart can be evaluated, as discussed herein below. In addition, the present invention is also useful for determining the contours of other organs in the patient's body. Furthermore although the preferred embodiment of the present invention is used in connection with a magnetic field system, other methods for tracking the position and orientation of the ultrasound transducer may be employed.

The relative intensities of each point or pixel in an ultrasound image depend on scattering of the ultrasound signal from tissues in the patient. The organ borders in these images are typically not clean lines, but instead, are somewhat indefinite areas with differing gray scale values. Thus, it can be difficult to manually determine the contours of the epicardium and endocardium in such images.

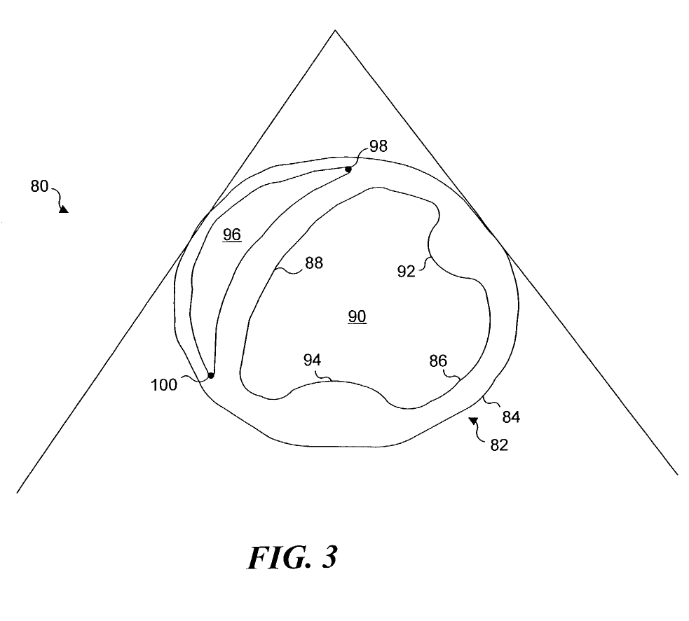

A transverse or short axis view forming a schematic image 80 of a left ventricle 82 in a patient's heart is shown in FIG. 3. An outer surface 84 (the epicardium) is clearly visible, as is an inner surface 86 (the endocardium). It must be stressed that this Figure and the other Figures discussed below schematically depict images in different ultrasound image planes, but do not show the gray scale data that would actually be seen in an ultrasound image. Thus, these Figures simply show the contours and the structure of the heart included in their respective image planes. Also evident in FIG. 3 are anterior and posterior papillary muscles 92 and 94, a chamber 90 enclosed by the left ventricle, a right ventricle 96, and anterior and posterior septal points 98 and 100, respectively, which are used to identify the lateral bounds of a septum 88.

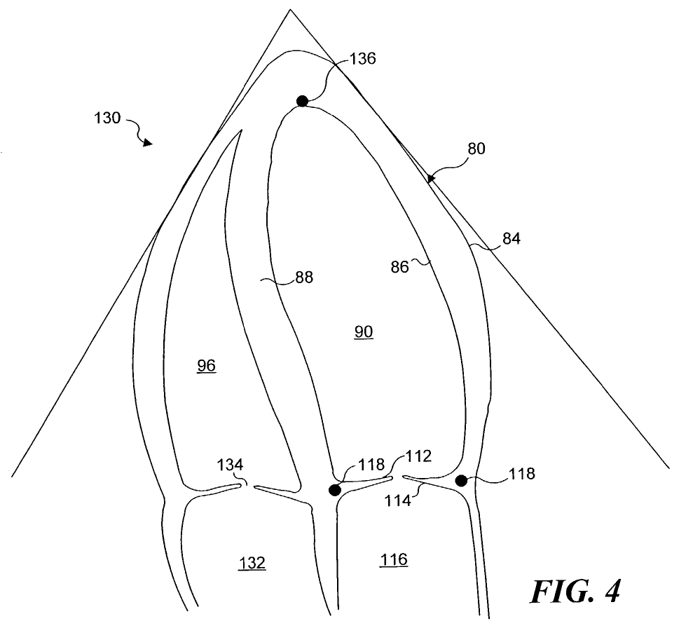

FIG. 4 shows a schematic representation 130 of an apical four chamber view of the patient's heart, including a left ventricle 82, with its enclosed chamber 90. The left ventricle is defined by endocardium 86 and epicardium 84. A portion of a left atrium 116 is visible at the right side of the schematic image. Additional anatomic landmarks are mitral valve annulus points 118, anterior and posterior mitral valve leaflets 112 and 114, respectively, right ventricle 96, and interventricular septum 88. This apical view also shows a right atrium 132, a tricuspid valve 134, and an apex of the left ventricle 136.

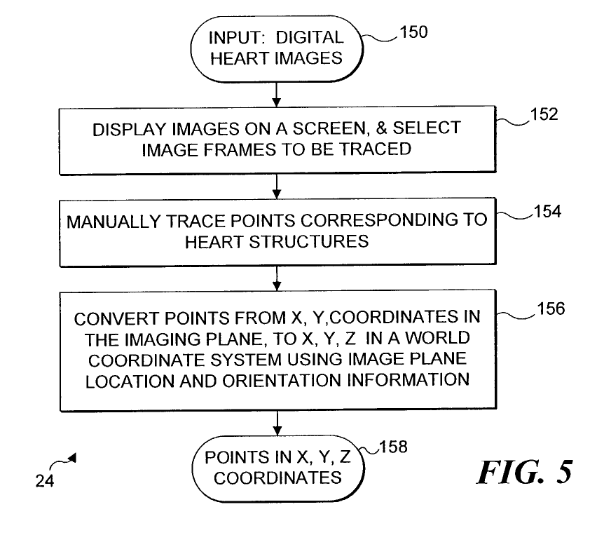

FIG. 5 illustrates details of block 24 (shown in FIG. 1), for manually tracing anatomic structures or landmarks of the heart from ultrasound images (or from images produced by other imaging modalities). These images are reviewed on display 54 (FIG. 2), and image frames are selected for tracing the specific anatomic landmarks, at certain time points in the cardiac cycle, usually the time of end diastole, when the heart is maximally filled with blood, and the time of end systole, when the heart has reached maximum contraction, as noted in a block 152 in this Figure. An ECG can be recorded during the imaging process. The ECG will provide cardiac cycle data for each of the image planes scanned that are usable to identify the particular time in the cardiac cycle at which that image was produced. The identification of the time points is assisted also by review of the images themselves, to detect those image frames in which the cross-sectional contour of the heart appears to be maximal or minimal. The structures of interest are then located in the image and traced manually using a pointing device, as indicated in a block 154. The 2D image coordinates of the points are converted into 3D coordinates in a common coordinate system in a block 158, using the position and orientation data recorded by magnetic field sensor 66 (FIG. 2), as noted in a block 156. Preferably, the selected points include the apex of the left ventricle, the aortic annulus and the mitral annulus; other anatomical landmark structures that may be used include the left ventricular free wall and interventricular septum.

In a preferred embodiment of the present invention, surfaces are represented by triangular meshes, somewhat like surface 170 shown in FIG. 8. A triangular mesh includes sets of faces, edges, and vertices. Each face is a triangle in R³ and contains 3 edges and 3 vertices. Each edge is a line segment in R³ and contains 2 vertices. Each vertex is a point in R³. The vertex positions determine the shape of the mesh. The vertices, edges, and faces of a mesh are referred to collectively as the simplices (singular “simplex”) of the mesh. A typical triangular mesh used to model the left ventricle has 576 faces. Although a preferred embodiment is described in terms of triangular meshes, the present invention is applicable to any surface representation that supports geometry optimization and averaging, including subdivision surfaces and NURBS, among many others.

The simplices of the mesh in FIG. 8 are labeled to indicate their association with specific anatomy. Thus, the face labels AL, AP, Al, AlS, AAS, and AA all start with the letter “A” to indicate that they are associated with the apex region of the left ventricle. As in U.S. Pat. No. 5,889,524, data and surface labeling are used in this preferred embodiment to constrain the distance calculation, resulting in faster and more robust fits.

In FIG. 6, the step of optimizing the surface fit to the points (indicated in block 28 of FIG. 1) is done by adjusting vertex positions. This adjustment is done using standard methods for numerical optimization, such as conjugate gradients, to optimize a measure of fit quality determined in a step 496. In the preferred embodiment, the fit quality measure includes distances from the data points to the surface, the surface area, the surface smoothness, etc.

Vertex positions can be adjusted directly by a numerical optimization algorithm, as discussed in U.S. Pat. No. 5,889,524. However, to constrain the fit to reasonable shapes, it is easier to re-parameterize the surface geometry, separating alignment parameters from ones controlling shape. In a preferred embodiment, this task is done by morphing, in a manner similar to that taught by Fleute and Lavallee. In a step 494, the fitted surface is expressed as a convex weighted average of shapes obtained from a knowledge base 492 (determined for a population of other hearts). The weights determine the “shape” of the surface, while the parameters of a Euclidean transform determine the fitted surface's size, location, and orientation. Fitting the surface in this way restricts its shape to be within the range of observed shapes in the knowledge base. A decision block 502 determines if the fit meets a predetermined criterion, and if not the parameters are adjusted, as indicated in a block 498. Once an acceptable fit is obtained, the result is a candidate ventricular surface, as shown in a block 504.

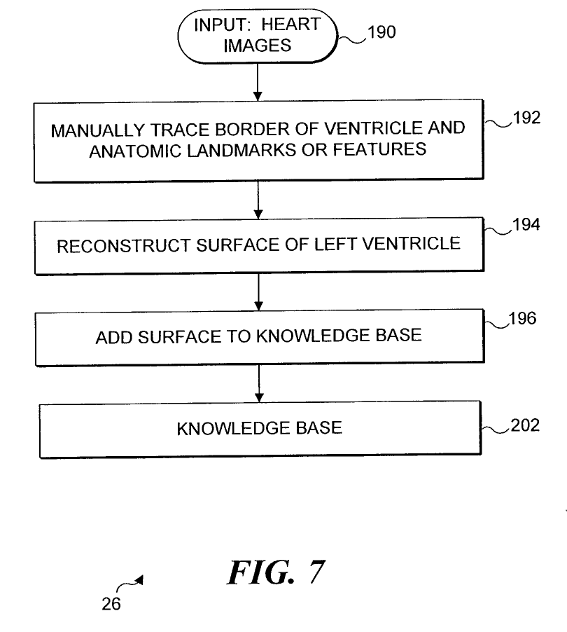

The present invention uses knowledge base 26 (shown in FIG. 1) to derive a surface of a heart that is subsequently adjusted so that its shape is consistent with the shape of the patient's heart in the observed images. A plurality of surfaces of the left ventricles in a population of hearts exhibiting a wide variety of types and severity of heart disease is used to represent 3D variations in the shape of the left ventricle. Specifically, based on an analysis of this population of hearts, knowledge base 26 is developed using the steps shown in FIG. 7.

As shown in a block 192 of FIG. 7, the knowledge base is created by manually tracing ultrasound images 190 of portions of the hearts (e.g., the left ventricle) for other individuals, producing a set of manually traced borders. This manual tracing step employs much the same process as that shown in FIG. 5, but many more points are traced than are used for automated detection. Preferably, the set of manually traced borders includes imaging data from at least five imaging planes for each of the hearts. As shown in block 194, a surface is reconstructed from these borders for the portion of the heart of interest, by a fitting method such as that described in U.S. Pat. No. 5,889,524 (McDonald et al.). The surface is then added to the knowledge base, in a block 196, and a set of all such surfaces yields the knowledge base, as shown in a block 202.

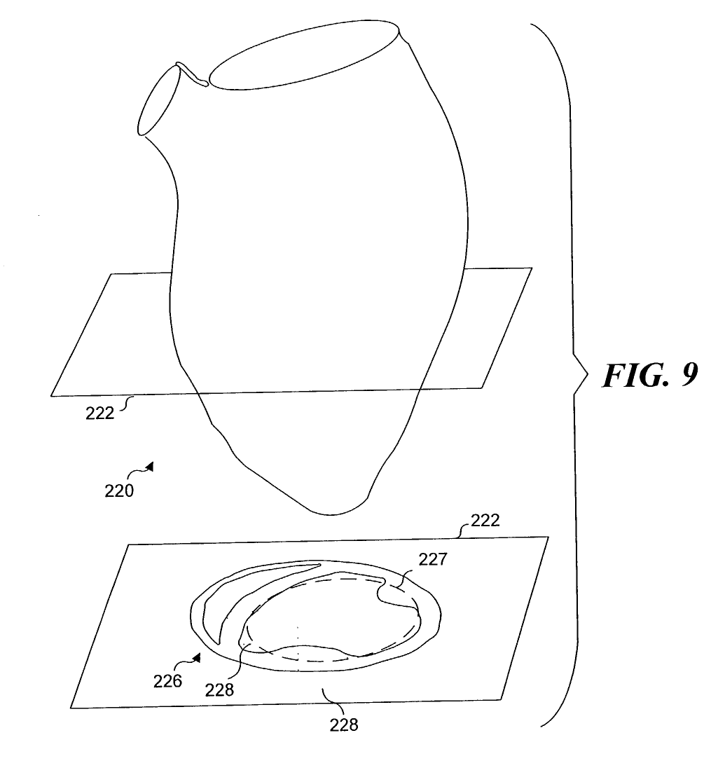

In FIG. 9, the intersection of a surface with an image plane 30 comprises a series of line segments, each line segment being associated with a face in the surface. In an exemplary image 226 from a plane 222, the intersection is a border 227. Border 227 is used to locate image regions 228, which are spaced apart around the border.

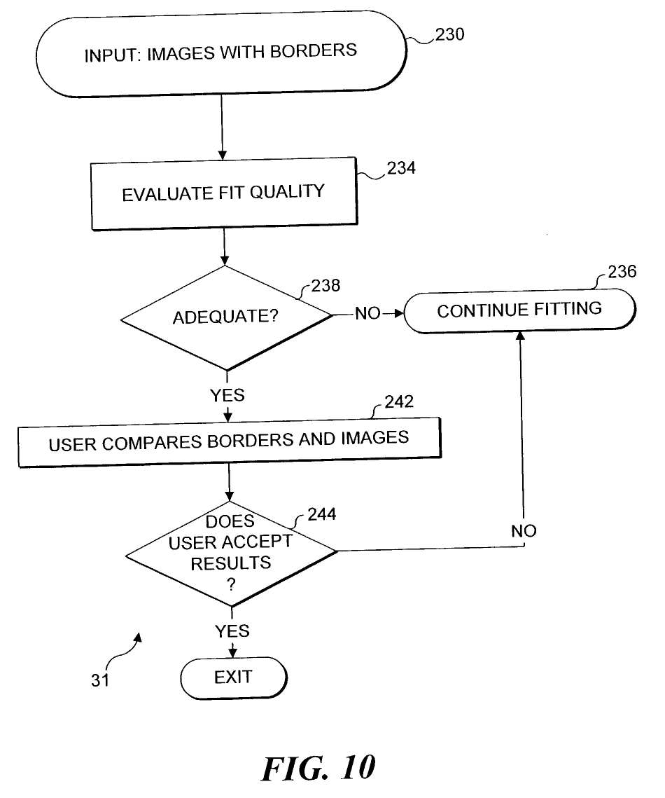

The details of determining whether candidate ventricular borders are adequate in decision block 31 of FIG. 1 are shown in FIG. 10. As noted in a block 230, images and their corresponding candidate ventricular borders are input to a block 234, in which the fit quality is evaluated. A block 238 determines if the most recent adjustment to the surface produced a surface matching the data points with an error that is less than a predefined threshold. If the error is less than the predefined threshold, the operator is given an opportunity to compare the candidate borders with the images of the patient's heart in a block 242. Otherwise, the logic continues with block 236, which continues the fitting process with decision block 33 (FIG. 1).

A decision block 244 indicates that the operator determines if the results are acceptable. The border obtained by intersecting the surface (endocardial or epicardial) of the adjusted surface of the left ventricle in any imaging plane can be reviewed and verified by the operator. If any border is not acceptable to the operator, then the process will continue with decision step 33 (FIG. 1), and it is likely that the operator will want to manually enter points to achieve a still closer match between the computed border and the observed images of the patient's heart. In decision block 244, the operator can visually inspect the border of the ventricle that is thus determined for consistency, for example, based upon a comparison of the border to the observed image. If the operator is satisfied with the results in decision block 244, the fitting process is terminated.

At this point, assuming that the portion of the heart being evaluated is the left ventricle, the method will have produced an output comprising surfaces representing the endocardial, epicardial, or both surfaces of the left ventricle. These surfaces can be used to determine cardiac parameters such as ventricular volume, mass, and function, ejection fraction, wall thickening, etc., as indicated in block 39 of FIG. 1.

In decision block 33 of FIG. 1, the decision not to manually add data points will lead to block 32 in FIG. 1 in which border points are automatically detected for use in refining the determination of a ventricular surface and ventricular borders. The details of the steps carried out for border point detection in block 32 are shown in FIG. 11. In a block 394, a search region of the image is extracted for each intersection candidate border according to a previously defined size, shape, and location relative to the candidate border. This region has a type based on face and view consistent with the border templates included in the knowledge base. In a block 396, the border template from the knowledge base with the same type is applied to this search image region along the candidate border. A different border template is used for each such image region along the candidate border. A similarity measure is computed for different border template positions within the search image region. The preferred similarity measure is cross correlation. The position with highest similarity is selected in a block 396, and its origin is used as a candidate border point. In a block 398, if the similarity measure exceeds a threshold, this position is retained for use in determining a corresponding likely candidate border point having 3D coordinates for use in the next surface optimization used to determine another candidate surface.

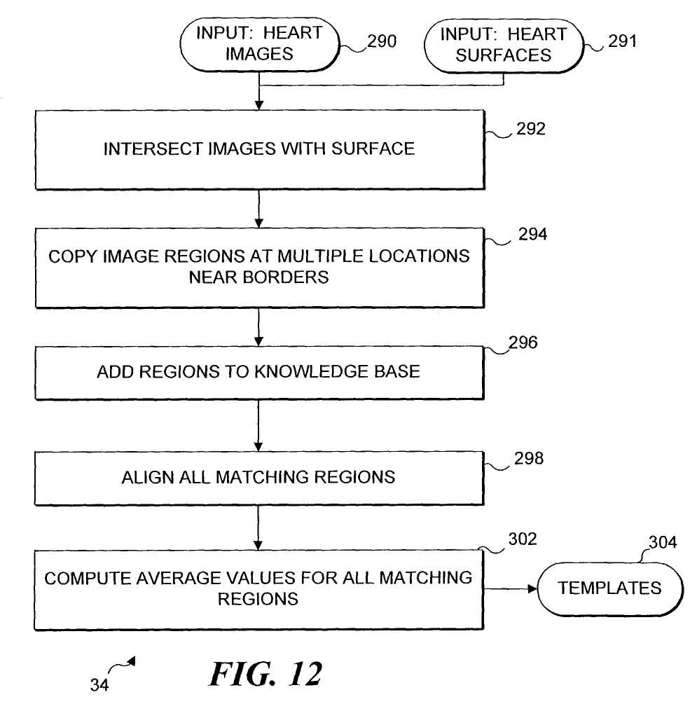

Knowledge base of border templates 34 (shown in FIG. 1) contains the border templates or reference patterns that were determined for each view and face by averaging smoothed grayscale values from previously acquired and processed studies, as shown in FIG. 12. The inputs for developing the knowledge base include heart images 290 and heart surfaces 291 for all of the other hearts to be used for the knowledge base. In a block 292, each image in the study to be added to the knowledge base is computationally intersected with the surface determined for that study, based on manual or automated processing. This intersection comprises a series of line segments comprising borders, with each line segment corresponding to a face of the surface. A region of predetermined size, shape, and location relative to the line segment is extracted from the image in the vicinity of each line segment and copied. Typically, the region surrounds the center point of its border line segment. Each region is appended to the knowledge base in a block 296. Each region is assigned a type in the knowledge base determined by its face and view. These views are standardized labels based on orientation (for example, parasternal or apical) and anatomic content (for example, four chamber or two chamber). Matching image regions are aligned in a block 298. In a block 302, image regions with the same type are combined to form templates 304, which are used for border point detection. Each template is assigned an origin, and the coordinates of the origin correspond to the center of the line segment comprising a border.

The surface is thus adjusted to fit the observed images for the patient's heart in an iterative process, finally yielding a surface that best represents the shape of the patient's heart. The process also ensures that this surface retains the anatomical shape expected of a human heart and that there is a close match between the intersection curves and the observed images.

It should be apparent that the present invention is equally applicable to determining the surface and borders of other internal organs that have been imaged. It is only necessary that the images of the organs and corresponding knowledge base for the corresponding organ of others be provided for use as described above.

Although the present invention has been described in connection with the preferred form of practicing it and modifications thereto, those of ordinary skill in the art will understand that many other modifications can be made to the present invention within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method for determining a surface of a patient's organ from sparse data points derived from images along image planes through the patient's organ, using a knowledge base of images and surfaces of other such organs, comprising the steps of:
(a) tracing the images of the patient's organ to obtain the sparse data points;
(b) deriving a candidate surface by fitting to the sparse data points, using surfaces from the knowledge base, said candidate surface corresponding to an anatomically feasible surface;
(c) intersecting the candidate surface with the image planes corresponding to the images of the patient's organ, yielding candidate borders for the patient's organ, each candidate border being associated with a different one of the image planes;
(d) determining if the candidate borders are consistent with the images of the patient's organ, and if so, employing the candidate surface for the surface of the patient's organ, but if not so, adding additional data points determined from the images of the patient's organ to the sparse data points and repeating steps (b)-(d) using the sparse data points and additional data points successively added in step (d) until the surface of the patient's organ is thus determined.

2. The method of claim 1, wherein the step of adding additional data points comprises the step of manually tracing the images of the patient's organ to identify the additional data points.

3. The method of claim 1, wherein the step of adding additional data points comprises the step of automatically detecting the additional data points within the candidate borders.

4. The method of claim 3, wherein the step of automatically detecting the additional data points comprises the steps of:
(a) extracting a plurality of image regions at a plurality of locations along the candidate borders;
(b) using border templates in the knowledge base for the other such organs, wherein each border template corresponds to a different on of the image regions, identifying positions of best fit for each border template in the image region to which it corresponds;
(c) retaining only the positions of best fit that meet predefined criteria; and
(d) computing the additional data points for use in deriving a new candidate surface from the positions of best fit that have been retained.

5. The method of claim 1, wherein the step of deriving a candidate surface comprises the steps of:
(a) determining a fitted surface expressed as a weighted average of shapes included in the knowledge base, said fitted surface being fitted to the sparse data points and any additional data points that have been added;
(b) determining a fit quality for the fitted surface; and
(c) adjusting parameters that define the fitted surface until the fit quality of the fitted surface satisfies a predetermined criteria, thereby yielding the candidate surface equal to a current fitted surface.

6. The method of claim 5, wherein the step of determining the fitted surface comprises the step of adjusting vertex positions of the shapes in the knowledge base until the weighted average conforms to the sparse data points and any additional data points that have been added.

7. The method of claim 1, wherein each intersection of one of the image planes with the candidate surface yields a different candidate border associated with the image plane, said candidate border defining an image region used for determining the additional data points.

8. The method of claim 1, further comprising the steps of displaying the surface of the patient's organ and using the surface to compute parameters indicative of a condition of the patient's organ.

9. The method of claim 1, further comprising the step of producing the images of the patient's organ using an ultrasonic imaging device that is disposed at known positions and orientations relative to the patient's organ.

10. The method of claim 1, further comprising the step of displaying the surface that was determined, to enable an operator to determine if the surface is anatomically consistent with the images of the patient's organ.

11. The method of claim 1, wherein the patient's organ is a heart, and wherein the other such organs are hearts.

12. A method for defining a surface of a patient's organ using a knowledge base of border templates derived from imaging other such organs, and sparse data points derived from images along image planes through the patient's organ, comprising the steps of:
(a) deriving a candidate surface that fits the sparse data points, said candidate surface corresponding to an anatomically feasible surface;
(b) intersecting the candidate surface with the image planes, yielding candidate borders, each candidate border being associated with a different image plane and the image of the patient's organ along the image plane;
(c) for each of a plurality of specific regions along each candidate border, selecting a position at which a corresponding border template most closely matches the image of the patient's organ associated with the candidate border, yielding a candidate border point for the region, a current set of candidate border points being thus defined for the candidate borders;
(d) repeating steps (a)-(c) using the sparse data points and successive sets of candidate border points, until the candidate border points comprising a current set of candidate border points do not differ substantially from candidate border point comprising a previous set of candidate border points in an immediately previous iteration, said candidate surface used to select the current set of candidate border points then defining the surface of the patient's organ.

13. The method of claim 12, wherein positions that are selected are defined within two dimensions, and wherein the candidate border points are defined within three dimensions, further comprising the step of computing each candidate border point from one of the positions that is selected.

14. The method of claim 13, further comprising the step of computing a similarity measure for each possible location of the border template within one of the specific regions and selecting as the position the location having the highest similarity measure.

15. The method of claim 14, wherein the similarity measure is determined using a cross correlation function.

16. The method of claim 14, further comprising the step of retaining only positions that meet predefined criteria for use in computing the candidate border points.

17. The method of claim 16, wherein the predefined criteria comprises a threshold for the similarity measure, such that positions having a similarity measure below the threshold are not retained.

18. The method of claim 12, wherein each intersection of one of the image planes with the candidate surface yields a different candidate border associated with the image plane, said plurality of specific regions used for determining the candidate border points being disposed at spaced apart intervals around the candidate borders.

19. The method of claim 12, further comprising the steps of displaying the surface of the patient's organ and using the surface to compute parameters indicative of a condition of the patient's organ.

20. The method of claim 12, further comprising the step of producing the images of the patient's organ using an ultrasonic imaging device that is disposed at known positions and orientations relative to the patient's organ.

21. The method of claim 12, further comprising the step of displaying the surface that was determined, to enable an operator to determine if the surface is anatomically consistent with the images of the patient's organ.

22. The method of claim 12, wherein the patient's organ is a heart, and wherein the other such organs are hearts.
